(19) United States
(12) Patent Application Publication
(10) Pub. No.: US 2021/0402713 A1
(43) Pub. Date: Dec. 30, 2021

(54) METHOD FOR PRODUCING A JOINT CONNECTION BETWEEN A STRUCTURAL COMPONENT MADE OF A PLASTIC AND A METAL COMPONENT

(71) Applicant: HELLA GmbH & Co. KGaA, Lippstadt (DE)

(72) Inventors: Michael LAKENBRINK, Oelde (DE); Jan Daniel WENZEL, Hamm (DE); Thomas WIESE, Lippstadt (DE)

(73) Assignee: HELLA GmbH & Co. KGaA, Lippstadt (DE)

(21) Appl. No.: 17/473,586

(22) Filed: Sep. 13, 2021

Related U.S. Application Data
(63) Continuation of application No. PCT/EP2020/055495, filed on Mar. 3, 2020.

(30) Foreign Application Priority Data
Mar. 12, 2019 (DE) 10 2019 106 284.5

(51) Int. Cl. B29C 65/00; B29C 65/14; B29C 65/16; B29C 65/20

(52) U.S. Cl. CPC B29C 66/30325; B29C 65/1412; B29C 65/16; B29L 2031/3002; B29C 66/227; B29C 66/742; B29C 65/20

(57) ABSTRACT

A method for manufacturing a joining connection between a structural part and a metal component of a lighting device of a vehicle, the method comprising at least the following steps: Generating a microstructure in a joining surface of the metal component, the microstructure having undercuts with respect to the joining surface; Softening the plastic material of the plastic part in an area of the complementary joining surface near the surface with the aid of an introduction of heat; Pressing the plastic part and the metal component together with a pressure force in such a way that a portion of the softened plastic material penetrates the undercuts of the microstructure; and Cooling the plastic material of the plastic part, forming a new strength of the softened plastic material of the plastic part.

This nonprovisional application is a continuation of International Application No. PCT/EP2020/055495, which was filed on Mar. 3, 2020, and which claims priority to German Patent Application No. 10 2019 106 284.5, which was filed in Germany on Mar. 12, 2019, and which are both herein incorporated by reference.

### BACKGROUND OF THE INVENTION

### Field of the Invention

The present invention relates to a method for manufacturing a joining connection between a structural part made from a plastic and a metal component, and a metal component of a lighting device of a vehicle.

### Description of the Background Art

A joint between a part made from a plastic and a metal component is known from DE 10 2014 109 114 A1, which corresponds to U.S. Pat. No. 10,145,530, which is incororated herein by reference. To join the plastic component to the metal component, a latching hook is shown by way of example on a first side and a screw element on an opposite second side. The example illustrates that connections between plastic parts and metal components in the construction of lighting devices for vehicles are usually complex and require multiple additional parts, adhesive joints or clamping joints being used to avoid geometric form-fitting connections, such as latching hooks and the like, and/or to avoid screw elements. The use of holding elements, such as springs and the like, is also common.

Thus, the conventioal art disadvantageously results in a complex design and installation of the joining connection, and multiple additional components or additional materials, such as screws, springs or adhesives and the like, are generally necessary.

A further disadvantage arises if a single-point, force-transferring connection is generated, for example in a screw connection or riveted connection, which occurs upon a mechanical loading of the joint. The connection is, in part, subjected to a high load, and the material, i.e. the plastic or the metal, may experience high local stresses in the connection area. Undesirable deformations result thereby, which are to be avoided, in particular in the case of narrow tolerances; the same is true with regard to the location and arrangement of luminously efficacious components, such as illuminant carriers, reflectors, lenses, light conductors and the like.

A method for manufacturing a joining connection is known from DE 10 2017 214 518 A1, in which a cast component is connected to a metallic structural element. The metallic structural element must be generatively manufactured, for example by powder bed methods, by selective laser sintering or selective laser melting. The surface of the metallic structural element has a surface structure, which comprises microdepressions, into which the casting material of the cast components may penetrate. This results in a form-fitting micro-joint formed over a wide area between the metallic structural element and the cast component. The applicability of the presented joining technology is disadvantageously transferable only to a limited extent, since not every metallic structural element may be manufactured using generative methods, in particular not for cost reasons, and a farther-reaching application is the method is moreover not known without forming a form-fit between the structural element and the cast component. The joining components are joined one inside the other in a form-fitting manner here.

### SUMMARY OF THE INVENTION

It is therefore an object of the present invention to provide a method for manufacturing a joining connection between a structural part made from a plastic and a metal component of a lighting device of a vehicle. The method is intended to easily result in a joint, which may be subjected to a high mechanical load, which is as gas- and liquid-tight as possible and does not cause any high-single-point stresses in the structural part and/or in the metal component. It is furthermore desirable if the method for manufacturing the joining connection, and thus the joint, makes it possible to easily maintain narrow tolerances without subsequent adjustment work being necessary.

The method according to an exemplary embodiment of the invention for manufacturing a joining connection between a structural part made from a plastic and a metal component of a lighting device of a vehicle proposes the following steps: Generating a microstructure in a joining surface of the metal component, the microstructure having undercuts with respect to the joining surface; softening the plastic material of the structural part in an area near the surface of the complementary joining surface by introducing heat; pressing the structural part and the metal component together with a pressure force in such a way that a portion of the softened plastic material penetrates the undercuts of the microstructure; and cooling the plastic material of structural part, forming a new strength of the softened plastic material of the structural part. Of course, the metal component may also be heated prior to the actual joining process, so that the structural part made from plastic is not already immediately cooled at the metal component when the contact of the two joining partners is manufactured.

If the method according to the invention for manufacturing a joining connection between a structural part made from a plastic and a metal component is used for a mounting in a lighting device of a vehicle, the generally sensitive light sources, lenses, light conductors, thick-walled optical elements, reflectors, illuminant carriers and the like to be installed in precise locations may be easily mounted in the lighting device with the aid of the structural parts made from a plastic, and no additional elements, such as screws, clamping elements or springs, are necessary. Moreover, no joining substances, such as adhesives or the like, are needed. A further advantage is the good adjustability of the relative location of the metal component with respect to the structural part made from a plastic.

The hybrid part formed with the joining connection may form a structural part within a luminous unit, i.e., a lighting device of a vehicle, for example a headlamp, and compensate for previous negative properties which are known per se. For example, temperature drifts may be compensated for by a targeted placement of the joining connection, for example to counteract a shifting of the bright/dark boundary even under a high mechanical load. If luminously efficacious components, such as lenses, reflectors, light sources and the like, are arranged on the hybrid part, they change their position to a much lesser extent, in particular under high mechanical load or with greater temperature differences.

The joining connections in the lighting device, for example when mounting light modules in a headlamp, have improved properties, in particular the fastening of the structural parts in or on the headlamp housing or on the receiving structure in the vehicle or, additionally or alternatively, the fastening of optically active parts on the structural part(s). The advantage of the joining connection according to the invention is the connection over a wide area without generating single-point joining connections, such as in a screw connection, so that no tension peaks occur in the sensitive luminous component.

The introduction of heat with the aid of contact heating elements is particularly advantageously generated with the aid of a laser irradiation or with the aid of an IR irradiation of the complementary joining surface of the structural part. The complementary joining surface forms the surface situated opposite the joining surface on the metal component. It is also conceivable that the metal component is heated and brought into contact with the plastic of the structural part. By a transfer of heat from the metal component into the structural part made from plastic, the area near the surface of the structural part in the joining surface is already heated and thus softened, so that the softened plastic material may penetrate the undercuts of the microstructure in the metal component. The introduction of heat may also take place by induction or being held in a furnace or by further suitable methods.

Material tongues penetrating the microstructure can be formed during the pressing together of the structural part made from plastic and the metal component with the softened plastic material, by means of which a form fit and/or a force fit is/are formed with the metal component. For example, the microstructure has holes, grooves or notches in the surface of the metal component, which penetrate the body of the metal component so as to run at an incline with respect to the surface. The inclination angle of the grooves or holes in the metal component may be alternately changed, so that the structural part may not be detached from the metal component in an extraction direction. In addition, it is possible to design the microstructure itself with undercuts, for example with the aid of increasing lateral dimensions of a microstructure at a greater depth within the metal component. Microstructures of this type may be produced, for example, by laser-based material removal or with the aid of etching methods. The geometric dimensions of the microstructures may be, for example 10 μm to 1,000 μm.

If material tongues form within the microstructure, which also run, in particular, at an incline to the surface and are oriented in different directions of incline, distributed over the joining surface, a form fit results between the structural part and the metal component. A force fit may also be formed, in particular due to slight shrinkage processes during the cooling of the plastic material, in particular in the area of the material tongues. The structural part interlocks with the surface of the metal component thereby in a certain way. The connection is thus permanently manufactured and, in particular, liquid- and gas-tight.

The microstructure in the joining surface of the metal component may have indentations or elevations. If the microstructure in the joining surface is provided with a raised design, the elevations penetrate the softened plastic and are surrounded thereby, so that a form fit and/or a force fit is/are formed after cooling the plastic.

The joining surface with the microstructure is further advantageously selected to be of the same size or smaller than a contact surface between the structural part and the metal component. Surface sections having a transfer of force between the structural part and the metal component may be created in a targeted manner, which may be designed in such a way that only slight mechanical loads occur in the joining zones, so that the actual contact surface between the parts may be significantly larger than the actual joining surface. Due to the only local use of the connection, contact areas between the structural part and the metal component may be generated in a targeted manner, which are arranged in such a way that an ideal transfer of force is achieved between the structural part and the metal component. The size of the joining surface is selected in such a way that the specific surface load during the transfer of force remains significantly below a damage limit, in particular of the plastic component of the hybrid part.

It is also advantageous that a single joining surface or multiple joining surfaces individually separated from each other having the microstructure are formed on a contact surface between the structural part and the metal component. For example, in the case of a rectangular contact surface between an optical element and a metallic carrier body, joining surfaces may be provided in the four corners of the rectangular shape, so that only a local heating, and no full-surface heating, of the surface of the structural part is necessary.

The metal component is further advantageously formed with the aid of an Mg alloy, an AL alloy, a Zn alloy or an Fe alloy, and/or the metal component is manufactured by means of a die casting method, an extrusion method, a forging method, with the aid of a machining manufacturing process and/or with the aid of a stamping/bending method.

An optical element receptacle, a module frame or a holder of the structural part is further preferably formed with the metal component, or holding lugs of the housing of the lighting device are formed with the metal component, and/or it is provided that the housing of a control unit is formed with the metal component or at least, in part, a housing of the lighting device of a vehicle is formed, or openings in a housing of the lighting device of a vehicle are closed. As a result, the control unit may be arranged with the joining connection according to the invention on a component in or on a housing of the lighting device, or the control unit is joined to the housing of the lighting device itself.

The joining surface having the microstructure between the structural part made from plastic and the metal component is advantageously selected in such a way that a thermal compensation of the location of the structural part as a frame, as a carrier body, as a housing and the like, relative to the installation environment, is achieved with the aid of the different coefficients of thermal expansion between the structural part made from plastic and the metal component.

The structural part and the metal component may have coefficients of thermal expansion which differ from each other, and the joining surface may be placed between the metal component and the structural part in such a way that a temperature drift is compensated for by utilizing the different coefficients of thermal expansion, for example, within luminously relevant positional tolerances of an optical component made from plastic.

It is also advantageous if the structural part and the metal component are pressed against each other with a handling system for the purpose of manufacturing the joint, the handling system being controlled in such a way that the location of the structural part is positioned in a compensating position on or at the metal component for the purpose of compensating for tolerances.

The structural part may be positioned relative to the metal component within certain limits while the plastic material near the surface is still softened. When the plastic material of the structural part cools again, the set, highly accurate position is frozen in a certain way, so that a positional tolerance of the structural part relative to the metal component remains permanently set.

The invention is furthermore directed to a joint made up of a structural part made from a plastic and a metal component, the joint being manufactured with the aid of the method described above. In particular, the metal component, together with the structural part made from plastic, forms a hybrid part, which, in turn, may itself form a structural part of a lighting device.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic cross-sectional view of the joint between the structural part made form a plastic and the metal component;

FIG. 2 shows a view of a structural part designed as a housing of a headlamp and a control unit;

FIG. 3 shows the view of a structural part as a housing and a holder made up of the metal component; and

FIG. 4 shows a schematic view of a headlamp, including its housing, which forms the structural part made from plastic, and holding lugs formed on the housing, which form the metal component.

### DETAILED DESCRIPTION

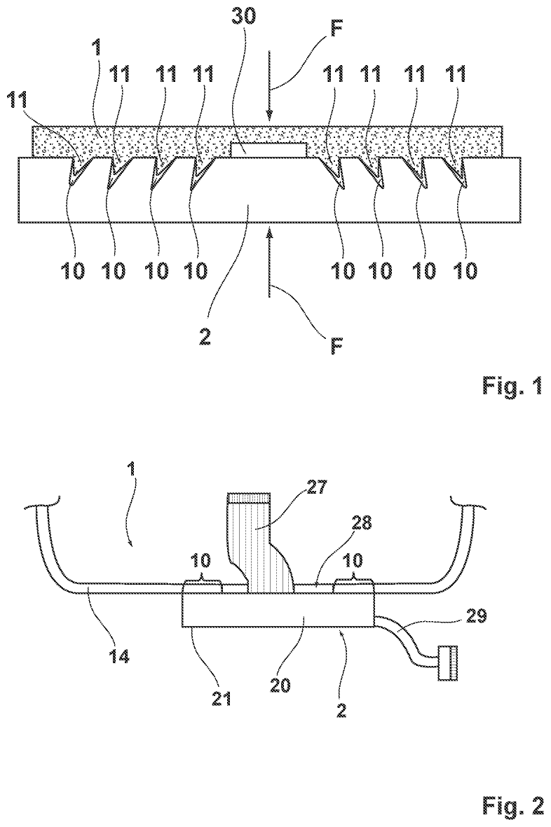

FIG. 1 shows a cross-sectional view of a joint between a structural part made from plastic 1 and a metal component 2. Structural part made from plastic 1 is shown in an abstract manner and is therefore designed, not illustrated in greater detail, as a carrier element, as a holding element or, for example, as a housing of a lighting device of a vehicle, for example a headlamp. Metal component 2 may form, for example, a reinforcement, a holder, a holding lug or the like.

Microstructures 10, which run at an incline starting from the surface into the body of metal component 2, are introduced into the surface of metal component 2 used as a contact surface to structural part made from plastic 1, the angle of inclination of the microstructures pointing in different directions, discernibly illustrated by way of example with left-side microstructures 10, with right-side microstructures 10 oriented in the opposite direction.

Microstructures 10 have been introduced into metal component 2, for example using a laser-based material removal method or an etching method. The representation of microstructure 10 is provided with an oversized design with reference to the thickness of metal component 2, and it is sufficient if microstructure 10 runs into the material at a depth of, for example, less than 1,000 μm, less than 500 μm or less than 200 μm starting from the surface.

To generate the joining connection, the complementary contact area of structural part made from plastic 1, i.e. the contact area opposite metal component 2, is first heated, for example using contact heating elements, by means of laser irradiation or by means of IR irradiation. Structural part made from plastic 1 is pressed with its subsequently softened surface onto microstructure 10 of metal component 2, applied pressure force F being represented by arrows. A portion of the softened plastic material of structural part 1 then penetrates microstructure 10 and forms material tongues 11, which interlock with undercut microstructure 10 after a cooling of plastic part 1 and thus form a form fit and possibly additionally a friction fit. A mechanically loadable joining connection is generated thereby between structural part made from plastic 1 and metal component 2 without a macroscopic form fit being necessary.

FIG. 2 shows an example of a portion of a housing 14, which forms structural part 1 made from a plastic and which may be housing 14 of a headlamp. An opening 28 is introduced into housing 14, and a control unit 21 is arranged on the outside in front of opening 28, so that, for example, a housing 20 of control unit 21 closes opening 28.

Housing 20 of control unit 21 forms, for example, metal component 2, which is joined to structural part 1 made from plastic, which forms structural component and is formed by housing 14.

In a joining area, the surface of housing 20 of control unit 21 is provided with a microstructure 10, so that control unit 21 may be arranged on the outside of housing 14 of the headlamp, using the method according to the invention, and thus also closes opening 28. An inner cable conduit 27 is inserted into the interior of housing 14, which may be connected, for example, to an illuminant or an actuator, and control unit 21 includes an outer cable conduit 29, which may be connected, for example, to the vehicle itself.

The joining area defined by microstructure 10 surrounds opening 28, for example completely, so that the latter is sealed liquid- and gas-tight upon the arrangement of control unit 21 and after the manufacturing of the joining connection.

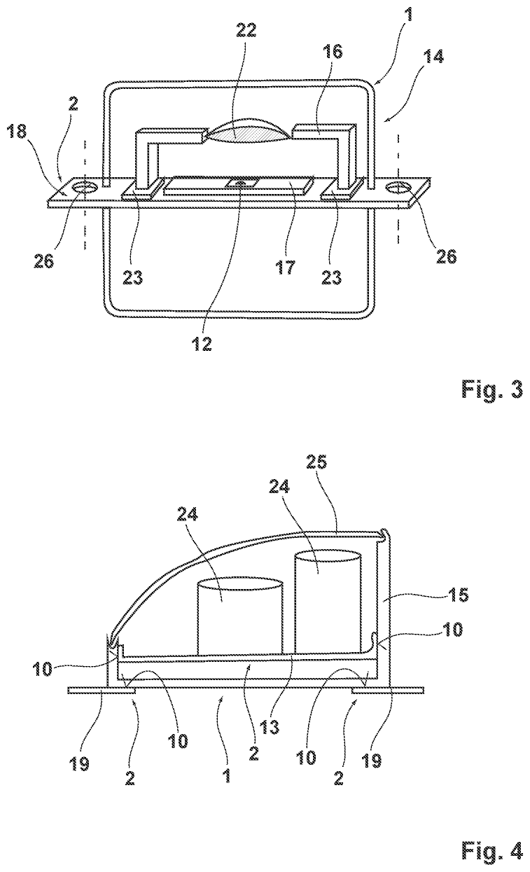

A mounting of the headlamp is illustrated schematically in FIG. 3, including a housing 14, and a light source 12 and an optical component 22 are accommodated in housing 14. Optical component 22 is held with the aid of an optical element holder 16, and a holder 18 extends through housing 14, which is brought out of housing 14 and which has screw holes 26, via which the headlamp may be fastened, for example, in the vehicle. Optical element holder 16 is arranged on holder 18 with the aid of contact sections 23; light source 12 is likewise accommodated on holder 18 with the aid of a carrier body 17.

Holder 18 forms, for example, a metal component 2, and housing 14 forms a structural part 1 made from a plastic, which has a joining connection to holder 18 manufactured in the manner according to the invention. Within the meaning of the invention, optical element holder 16 is further mounted on holder 18 with the aid of contact sections 23 in a manner according to the invention, using a joining connection; carrier body 17 for light source 12 may be mounted on holder 18 in the same way.

FIG. 4 shows a further example of a headlamp, including a housing 15, in a schematic view, housing 15 forming structural part 1 made from a plastic. In housing 15, an optical element receptacle 13 is configured to accommodate optical components 24, and a plastic lens is arranged on housing 15. Optical element receptacle 13 may form a metal component 2 with areas of a microstructure 10, via which optical element receptacle 13 is fastened in the interior of housing 15 in the manner according to the invention.

Holding lugs 19 made from metal are furthermore arranged on the outside of housing 15, which have particular microstructures 10 in a joining area to housing 15, via which holding lugs 19 are connected to the plastic material of housing 15 in the manner according to the invention.

The design of the invention is not limited to the preferred exemplary embodiment specified above. Instead, a number of variants are conceivable, which make use of the illustrated approach, even in fundamentally different designs. All features and/or advantages arising from the claims, the description or the drawings, including structural details, spatial arrangements and method steps, may be essential to the invention individually as well as in a wide range of combinations.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for manufacturing a joining connection between a structural part made from a plastic and a metal component of a lighting device of a vehicle, the method comprising:
generating a microstructure in a joining surface of the metal component, the microstructure having undercuts with respect to the joining surface;
softening the plastic material of the structural part in an area of the complementary joining surface near the surface with the aid of an introduction of heat;
pressing the structural part and the metal component together with a pressure force such that a portion of the softened plastic material penetrates the undercuts of the microstructure; and
cooling the plastic material of the structural part thereby forming a new strength of the softened plastic material of the plastic part.

2. The method according to claim 1, wherein the introduction of heat is generated with the aid of contact heating elements, by a laser irradiation or by an IR irradiation.

3. The method according to claim 1, wherein material tongues, which penetrate the microstructure with the softened material, are formed when pressing together the structural part and the metal component via which a form fit and/or a force fit is/are formed with the metal component.

4. The method according to claim 1, wherein the joining surface with the microstructure is of the same size or smaller than a contact surface between the structural part and the metal component.

5. The method according to claim 1, wherein a single joining surface or multiple individually separately formed joining surfaces having the microstructure are formed on a contact surface between the structural part and the metal component.

6. The method according to claim 1, wherein the metal component is formed with the aid of an Mg alloy, an Al alloy, a Zn alloy or an Fe alloy, and/or is manufactured by a die casting method, an extrusion method, a forging method, with the aid of a machining manufacturing process and/or with the aid of a stamping/bending method.

7. The method according to claim 1, wherein a housing of the lighting device, a lens holder, a frame body, a carrier body or the like is formed with the structural part formed from plastic.

8. The method according to claim 1, wherein an optical element receptacle holder of the structural part or holding lugs of the housing of the lighting device are formed with the metal component, and/or the housing of a control unit is formed with the metal component.

9. The method according to claim 1, wherein the joining surface having the microstructure between the structural part and the metal part is selected such that a thermal compensation of the location of the structural part is achieved with the aid of the different coefficients of thermal expansion between the structural part and the metal component.

10. The method according to claim 1, wherein the structural part and the metal component are pressed against each other with a handling system, the handling system being controlled in such a way that the location of the structural part is positioned in a compensating position on or at the metal component for the purpose of compensating for tolerances.

11. A joint formed of a structural part and a metal component manufactured via the method according to claim 1.

12. The joint according to claim 11, wherein the metal component forms a holder of the structural part, and/or the metal component forms a holding lug for the holding accommodation of a lighting device in the structure of a vehicle.
